(19) United States
(12) Patent Application Publication
(10) Pub. No.: US 2026/0270740 A1
(43) Pub. Date: Sep. 10, 2026

(54) LOCAL CARRIER ASSESSMENT AT AN INSTALLATION SITE

(71) Applicant: ITRON, INC., Liberty Lake, WA (US)

(72) Inventors: Eric S. BENSON, Spokane Valley, WA (US); Venkatesh GOURABATHUNI, Bangalore (IN); Asa Jay LAUGHTON, Medical Lake, WA (US); Christopher Lloyd OSTERLOH, Waseca, MI (US)

(21) Appl. No.: 19/374,212

(22) Filed: Oct. 30, 2025

Related U.S. Application Data
(60) Provisional application No. 63/768,393, filed on Mar. 7, 2025.

(51) Int. Cl. H04W 24/08; H04W 24/10

(52) U.S. Cl. CPC H04W 24/08; H04W 24/10

(57) ABSTRACT

Various embodiments disclose a method including connecting, by an endpoint device, to a network sector to establish a cellular connection, wherein the network sector corresponds to a carrier network, performing, by a registration application operating on the endpoint device, a cellular assessment that acquires a plurality of signal quality measurements for the cellular connection, and providing, by registration application to an endpoint, the plurality of signal quality measurements, wherein the plurality of signal quality measurements are usable by the endpoint to display an overall assessment value that is based at least on the plurality of signal quality measurements.

### CROSS-REFERENCE TO RELATED APPLICATIONS

This application claims priority benefit of the United States Provisional Patent Application titled, “LOCAL CARRIER ASSESSMENT AT AN INSTALLATION SITE,” filed on Mar. 7, 2025, and having Serial No. 63/768,393. The subject matter of this related application is hereby incorporated herein by reference.

### BACKGROUND

### Field of the Various Embodiments

The various embodiments relate generally to local carrier assessment at an installation site, and more specifically, to performing on-site cellular connectivity assessments by an endpoint device during installation.

### Description of the Related Art

Many enterprises deploy large numbers of endpoint devices that are generally stationary, such as power meters, water meters, street light controllers, traffic controllers, and/or the like, as well as back-office management systems that monitor and/or control the endpoint devices. To deploy meters and other endpoint devices over a large geographic area, various carrier networks operated by different network providers under different access conditions are utilized. Carrier networks can provide coverage that is separated into a number of sectors. Each sector provides connectivity to managed endpoint devices, as well as other devices from other users. Different carrier networks can provide connectivity using different towers, transport protocols, security requirements, and/or the like. As a result, connectivity, outages, speed, latency, and other carrier network parameters can differ from network to network, sector to sector within the same network, and the actual location at which an endpoint device is installed.

### BRIEF DESCRIPTION OF THE DRAWINGS

So that the manner in which the above recited features of the various embodiments can be understood in detail, a description of the inventive concepts may be had by reference to various embodiments, some of which are illustrated in the appended drawings. It is to be noted, however, that the appended drawings illustrate only typical embodiments of the inventive concepts and are therefore not to be considered limiting of scope in any way, and that there are other equally effective embodiments.

FIG. 1 is a conceptual diagram of a networked environment that includes an endpoint device and one or more network carriers, according to various embodiments;

FIG. 2 is a block diagram of a computing system of an endpoint device, according to various embodiments;

FIG. 3 is a block diagram of a computing system of a mobile device, according to various embodiments;

FIG. 4 is a diagram of a cellular assessment interface displaying a cellular assessment, according to various embodiments;

FIG. 5 is a flow diagram of method steps for performing a cellular assessment, according to various embodiments; and

FIG. 6 is a flow diagram of method steps for requesting a cellular assessment and generating an overall cellular assessment result, according to various embodiments.

### DETAILED DESCRIPTION

In the following description, numerous specific details are set forth to provide a more thorough understanding of the various embodiments. However, it will be apparent to one skilled in the art that the inventive concepts may be practiced without one or more of these specific details.

A given endpoint device can experience poor connectivity with a sector of the particular carrier due to factors such as the location of the endpoint device (e.g. , the endpoint device experiencing high interference or low signal quality due to physical obstructions in the environment). A field worker can install an endpoint device at a specific location and perform in-field programming of the endpoint device. The endpoint device is fixed at the specific location (e.g., installed in a socket, mounted on a power pole, installed in a subterranean box, etc.). During installation, the endpoint device does not communicate with the network sector, does not have full network connectivity, and typically relies on instructions from another local device (e.g., a mobile device of the field worker) via a wired or a short-range wireless (e.g., a Bluetooth connection). In order to establish full network connectivity, the endpoint device typically establishes a cellular connection with a local network sector at the end of the installation. When there is a choice from multiple network sectors, a suitable network sector is selected during the installation. In prior approaches, the field worker installing the endpoint device manually assessed the connection between an endpoint device and a network sector. For example, the field worker could use available information, such as coverage maps provided by the carrier network, to perform carrier assessment with respect to the location of the endpoint device. However, carrier maps typically depict coverage for endpoint devices that are located at a height above the ground and often do not address the actual location of endpoint devices, which might be installed in cluttered areas, in a hole in the ground, etc.

To address the deficiencies of carrier maps, the field worker could also attempt to use a separate device (e.g., handheld mobile device) to assess the quality of a particular network sector or carrier based on the signal strength, etc. observed by the separate device. However, the separate device often is unable to assess the actual connection the endpoint device will be using because the separate device has different communication hardware, often cannot be placed in the actual installation location, and may not have service compatible with the network sector or the carrier network.

Other techniques can include installing the endpoint device and asking the endpoint device to connect once the installation is complete. For example, once installation is complete, the endpoint device can continue attempting to connect to the network sector for a defined period of time (e.g. , 15 minutes) after the last configuration command from the field worker, in order to establish initial communication with the carrier network. This process is time-consuming, especially when a connection cannot be made and the field worker has to repeat the installation with different hardware or by specifying a different carrier.

To address the deficiencies described above, an endpoint device includes a registration application that performs cellular assessments at the site of installation to determine the health of a connection between the endpoint device and a network sector. The registration application receives commands from a registration companion application operating on a mobile device of the field worker. The registration application responds to the commands by performing a cellular assessment and acquiring measurement data relating to the signal strength, signal quality, interference level of the connection to a particular network sector, and/or the like. The registration application transmits the measurement data to the registration companion application using a short-range wireless or wired connection. The registration companion application processes the measurement data to compute an overall assessment value (e.g., green, yellow, or red classification) based on thresholds for signal quality and registration status. The companion application then displays a summary of the cellular assessment properties, including reference signal received power (RSRP), reference signal received quality (RSRQ), signal-to-interference-plus-noise ratio (SINR), registration success or failure, assessment duration, and cell identifier, along with the overall assessment value on a user interface, thereby enabling the installer to determine connectivity viability at the installation site. Based on the summary, the field worker can determine whether the endpoint device is to maintain the current connection to the network sector, whether the endpoint device is to register with a different network sector and/or a different network carrier, whether to install the endpoint device at a different location, or whether to install a different endpoint device at the site.

At least one technical advantage of the disclosed techniques is that, with the disclosed techniques, the viability of a cellular connection for an endpoint device can be assessed directly and locally at the installation site using the endpoint device, rather than inferred from carrier coverage maps or estimated using separate handheld devices. Accuracy of the assessment is improved by using the actual endpoint device hardware and software to attempt registration and capture signal quality metrics, thereby reflecting the real conditions the endpoint device will experience in situ. Deployment efficiency is improved by providing field workers with immediate assessments of the cellular connection, reducing costly repeat visits and minimizing downtime caused by non-communicating devices. These technical advantages represent one or more technological improvements relative to existing carrier assessment approaches for stationary endpoint devices.

### Infrastructure for Cellular Assessment

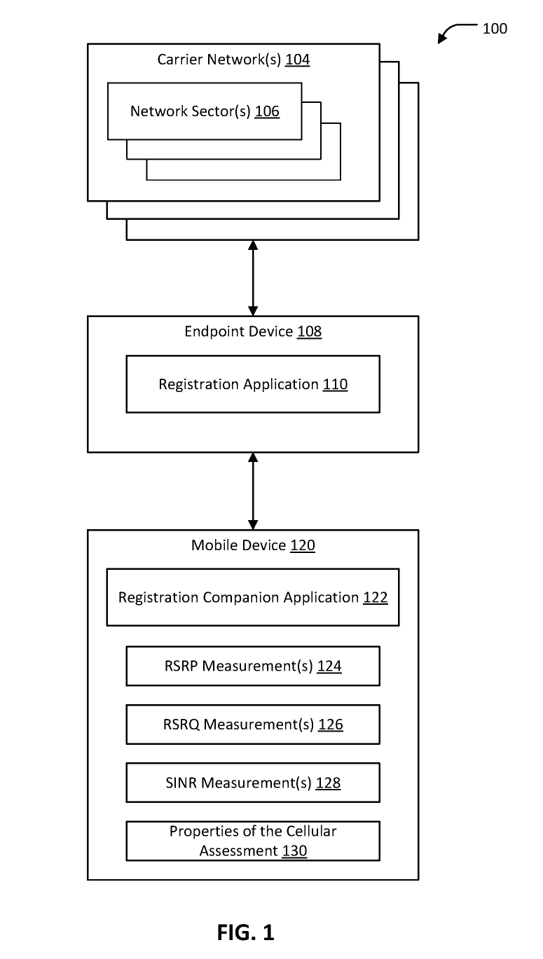

FIG. 1 is a conceptual diagram of a networked environment that includes an endpoint device and one or more network carriers, according to various embodiments. As shown, the networked environment 100 includes, without limitation, one or more carrier networks 104, one or more network sectors 106, an endpoint device 108 and a mobile device 120. The endpoint device 108 includes, without limitation, a registration application 110. The mobile device 120 includes, without limitation, a registration companion application 122, one or more RSRP measurements 124, one or more RSRQ measurements 126, one or more SINR measurements 128, and one or more properties of a cellular assessment (also referred to as cellular assessment characteristics) 130.

Each of the one or more carrier networks 104 provides a cellular or other type of wide area network. For example, each of the one or more carrier networks 104 can be a cellular network. Each of the one or more carrier networks 104 includes one or more network sectors 106. A given carrier network 104 includes, without limitation, one or more base stations, one or more network devices such as routers, switches, and gateways, one or more radio communications devices, and so on. The carrier network 104 provides one or more base stations corresponding to one or more cells. Each carrier network 104 includes one or more network sectors 106, such as one, two, three, four, five, six, or more network sectors 106. As a result, a carrier network 104 provides network coverage using the plurality of network sectors 106 over a geographic area.

The endpoint device 108 can be a node in the networked environment 100 that connects to any of the network sectors 106 included in any of the carrier networks 104. In various examples, the endpoint device 108 is a stationary device that is physically fixed and/or statically located in a particular geographic location. In various embodiments, the endpoint device 108 is installed in a socket, mounted on a power pole, installed in an underground utility box, and/or the like. In various embodiments, the endpoint device 108 is a utility meter used to measure the consumption of one or more utility commodities (e.g., electricity, water, gas, internet, etc.), a streetlight controller, and/or the like. In other embodiments, the endpoint device 108 is an internet of things (IoT) device such as a camera, security device, asset tracker, chemical sensors (e.g., a methane sensor), and/or the like. A given endpoint device 108 uses one or more processors to execute the registration application 110. The endpoint device 108 uses one or more storage devices to store instructions, including the registration application 110, as well as measurement data used to provide the RSRP measurements 124, the RSRQ measurements 126, the SINR measurements 128, and/or the one or more properties of the cellular assessment 130. In various embodiments, the endpoint device 108 generates the one or more properties of the cellular assessment 130, such as network sector data (e.g., sector identifier, cell tower identifier, operator, or band), registration information (e.g., registration success or failure), additional assessment parameters (e.g., timestamp of the assessment, duration of the assessment, and sample count), and/or the like. In such instances, the endpoint device 108 transmits the one or more properties of the cellular assessment 130 to the registration companion application 122. In some embodiments, the endpoint device 108 stores a subscriber identity module (SIM) identifier that is usable to connect to the one or more carrier networks 104, and which may be included as an endpoint identifier within the properties of the cellular assessment. The SIM identifier refers to an International Mobile Subscriber Identity (IMSI) number or another identifier that uniquely identifies a particular SIM.

The registration application 110 assesses a connection between the endpoint device 108 and one of the carrier networks 104. In various embodiments, the registration application 110 attempts to connect to a network sector 106 of a carrier network 104 by exchanging various signals and messages with the network sector 106. During the registration, the registration application 110 acquires signal quality measurements or signal measurements (e.g., RSRP measurement 124, RSRQ measurement 126, and SINR measurement 128), as well as various properties of the registration attempt (e.g., the one or more properties of the cellular assessment 130). In some embodiments, the registration application 110 stores the acquired information in a local data store (not shown). In some embodiments, the registration application 110 stores multiple sets of information relating to multiple carrier assessments of the network sector 106 over time. The registration application 110 can respond to requests from the registration companion application 122 to retrieve information relating to one or more previous connectivity assessments by retrieving the applicable information from the local data store and transmitting the applicable information to the mobile device 120.

The mobile device 120 performs data collection and/or network management functions relating to the endpoint device 108. In various embodiments, the mobile device 120 can include, without limitation, a smartphone, a tablet computer, a handheld computer, a wearable device, a virtual reality (VR) console, an augmented reality (AR) console, a laptop computer, a portable media player, a gaming device, and so forth. In various embodiments, the mobile device 120 includes the registration companion application 122.

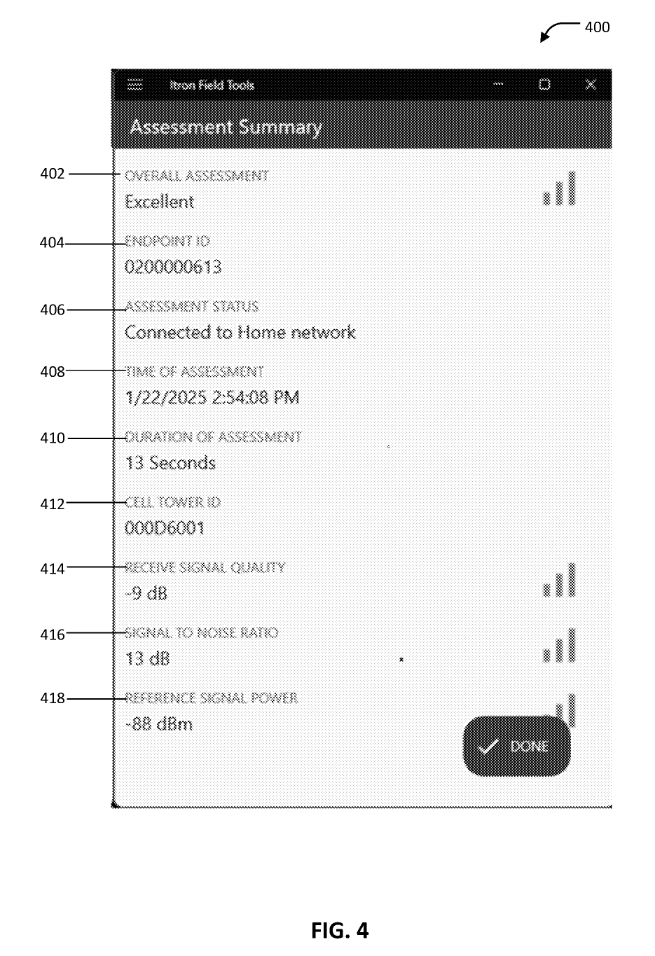

The registration companion application 122 sends a command to the registration application 110 to perform the carrier assessment for a given network sector 106. Upon completing the carrier assessment, the registration application 110 can provide the acquired information to the mobile device 120 in different ways. In some embodiments, the registration companion application 122 transmits a command to retrieve the information from the registration application 110. In other embodiments, the registration application 110 automatically transmits the acquired signal quality measurements and properties of the cellular assessment to the mobile device without requiring a specific command. In various embodiments, the registration companion application 122 acquires the RSRP measurements 124, the RSRQ measurements 126, and/or the SINR measurements 128, as well as the one or more properties of the cellular assessment 130. Using the acquired information, the registration companion application 122 generates an interface that summarizes the measurement data and/or the endpoint-originated information for the field worker. As will be discussed in relation to FIG. 4, the interface can include an overall assessment that is based on a combination of the information. For example, the registration companion application 122 can generate an overall assessment that is based on a combination of RSRP measurement 124, RSRQ measurement 126, and SINR measurement 128 and a registration status (e.g., success or failure, error code indicating where the failure occurred, etc. indicating a connection status and/or a connection state) that is included in the properties of the cellular assessment 130.

### Endpoint Device

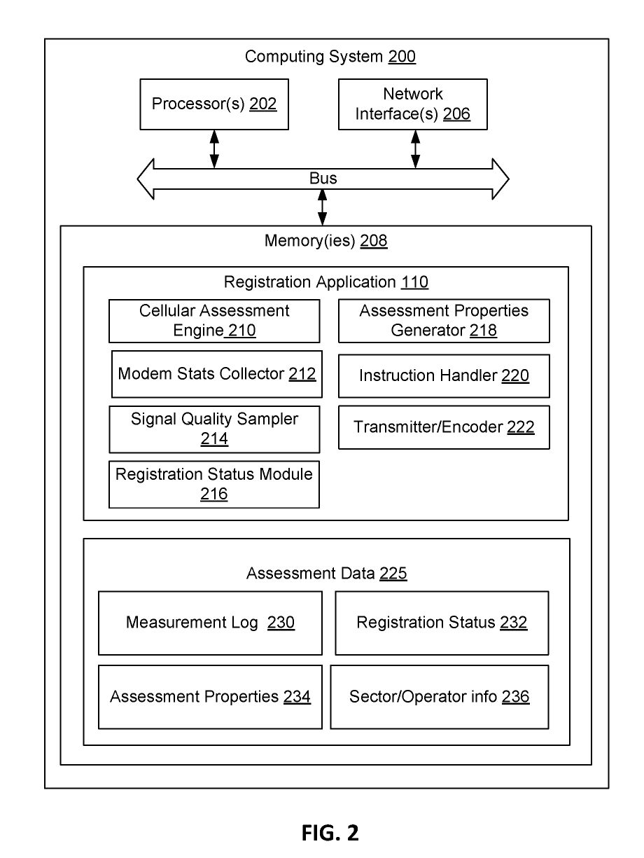

FIG. 2 is a block diagram of a computing system 200 of an endpoint device, according to various embodiments. The computing system 200 includes, without limitation, one or more processors 202, one or more network interfaces 206, and one or more memories 208, coupled together and in communication via a bus. The one or more memories 208 include, without limitation, the registration application 110 and assessment data 225. The registration application 110 includes, without limitation, a cellular assessment engine 210, a modem statistics collector 212, a signal quality sampler 214, a registration status module 216, an assessment properties generator 218, an instruction handler 220, and a transmitter/encoder 222. The assessment data 225 includes, without limitation, a measurement log 230, a registration status 232, assessment properties 234, and sector and operator information 236.

In some embodiments, the computing system 200 is implemented within the endpoint device 108 shown in FIG. 1. The one or more processors 202 execute operations of the computing system 200. In various embodiments, a processor 202 includes hardware configured to process data and execute instructions of the registration application 110 and related modules. The processor 202 can be any technically feasible processing device configured to process data and execute program instructions. For example, the processor 202 can include one or more central processing units (CPUs), digital signal processors (DSPs), graphics processing units (GPUs), application-specific integrated circuits (ASICs), field-programmable gate arrays (FPGAs), microprocessors, microcontrollers, other types of processing units, and/or a combination of different processing units.

The one or more network interfaces 206 include devices configured to transmit and receive data between the endpoint device 108 and external systems. In various embodiments, the network interfaces 206 support communication with one or more carrier networks 104 through the network sectors 106 to establish cellular connections used during registration and assessment. In some embodiments, the network interfaces 206 also support short-range or wired communication with the mobile device 120 for transferring the plurality of signal quality measurements and properties of the cellular assessment. A network interface 206 can include, for example, a cellular modem, a wireless transceiver such as a Bluetooth or Wi-Fi interface, an Ethernet interface, a serial interface, any other hardware device configured to transmit and/or receive digital communications between the endpoint device 108 and another device and/or network, and/or the like.

The one or more memories 208 include any technically feasible memory and/or storage device, such as a random-access memory (RAM) module, a flash memory unit, a solid-state drive, non-volatile storage, or any other type of memory unit or combination thereof. The one or more memories 208 stores executable components of the registration application 110, including the cellular assessment engine 210, modem statistics collector 212, signal quality sampler 214, registration status module 216, assessment properties generator 218, instruction handler 220, and transmitter/encoder 222. The one or more memories 208 also stores assessment data 225, including measurement log 230, registration status 232, assessment properties 234, and sector and operator information 236.

The registration application 110 includes executable instructions stored in the one or more memories 208 and executed by the one or more processors 202 to perform cellular assessments at the installation site of the endpoint device 108. The registration application 110 coordinates the operations of the computing system 200 to establish a cellular connection with one or more network sectors 106, acquire a plurality of signal quality measurements, and generate properties of a cellular assessment. The registration application 110 executes instructions to initiate network registration, capture RSRP measurement 124, RSRQ measurement 126, and SINR measurement 128 values, determine registration success or failure, and produce additional assessment information such as timestamps, duration of assessment, and cell or sector identifiers. The registration application 110 transmits the signal quality measurements and the assessment properties to the mobile device 120 for processing and display by the registration companion application 122.

The cellular assessment engine 210 executes the core assessment operations of the registration application 110. The cellular assessment engine 210 initiates connection attempts with one or more network sectors 106, controls the timing and sequencing of assessment operations, and ensures that the endpoint device 108 captures accurate signal quality measurements (e.g., RSRP measurements 124, RSRQ measurements 126, SINR measurements 128, registration success or failure information, timestamps of the assessment, duration of the assessment, sector identifiers, cell tower identifiers, and/or the like) during registration. The cellular assessment engine 210 coordinates the activities of the other modules, including the modem statistics collector 212 and the signal quality sampler 214, to provide a consistent assessment workflow. In some embodiments, the cellular assessment engine 210 manages assessment duration, retries, and error handling, thereby enabling reliable collection of connectivity information at the installation site.

The modem statistics collector 212 gathers information provided by the cellular modem of the endpoint device 108 during a registration attempt. The modem statistics collector 212 acquires data for modem state information generated during the registration attempt. The modem statistics collector 212 stores these values in association with the current assessment instance for later transmission to the mobile device 120. In some embodiments, the modem statistics collector 212 also normalizes or formats data received from different modem implementations to provide a uniform set of statistics to the cellular assessment engine 210 and the assessment properties generator 218.

The signal quality sampler 214 acquires radio signal quality values during a cellular assessment. The signal quality sampler 214 measures and records RSRP measurement 124, RSRQ measurement 126, and SINR measurement 128. The signal quality sampler 214 captures multiple samples within the time window of an assessment and provides these measurements to the assessment properties generator 218 for classification and analysis. The signal quality sampler 214 executes directly on the endpoint device 108 hardware to ensure that the collected values accurately reflect the in-situ radio conditions experienced by the endpoint device.

The registration status module 216 determines whether the endpoint device 108 successfully registered with the selected network sector 106 during the cellular assessment. The registration status module 216 evaluates messages exchanged between the endpoint device 108 and the carrier network 104 to determine a binary success or failure status, as well as intermediate states such as retries, partial registrations, or authentication failures. The registration status module 216 records the registration outcome as the registration status 232 within the assessment data 225 and provides this status to both the cellular assessment engine 210 and the assessment properties generator 218.

The assessment properties generator 218 produces a structured set of properties that describe the results of a cellular assessment. The assessment properties generator 218 generates a comprehensive set of assessment properties 234 by incorporating the registration outcome from the registration status module 216 and supplemental information from the modem statistics collector 212, and by associating those properties with the signal quality values recorded separately in the measurement log 230. These properties can include, without limitation, timestamps of assessment initiation and completion, assessment duration, sector and operator identifiers, registration success or failure, error codes, and/or the like. The assessment properties generator 218 organizes the properties into a format suitable for storage in the one or more memories 208 as part of the assessment data 225, including recording contextual details in the assessment properties 234, maintaining the registration outcome in the registration status 232, and associating sector and operator identifiers with the sector and operator information 236, for subsequent transmission to the mobile device 120.

The instruction handler 220 processes incoming commands from the mobile device 120 through the network interface 206. The instruction handler 220 interprets requests to initiate a cellular assessment, retrieve previously stored results, or adjust configuration parameters such as assessment duration or retry counts. The instruction handler 220 ensures that valid instructions are delivered to the cellular assessment engine 210 for execution and that responses are transmitted back to the mobile device 120. In this way, the instruction handler 220 serves as the communication gateway between the registration companion application 122 and the registration application 110. For example, the instruction handler 220 can process a command from the mobile device 120 to initiate a new cellular assessment and respond with the resulting signal quality measurements and assessment properties once the assessment is complete. In another example, the instruction handler 220 can process a request to retrieve historical results stored in the assessment data 225 and respond by transmitting the corresponding measurement log 230, registration status 232, and assessment properties 234 associated with a prior assessment.

The assessment data 225 stores data generated during execution of the registration application 110. The assessment data 225 includes, without limitation, a measurement log 230, a registration status 232 that correspond to a particular cellular assessment instance, an assessment properties 234, and a sector/operator information 236. The measurement log 230 maintains the signal quality values sampled by the signal quality sampler 214, including multiple entries of RSRP measurement 124, RSRQ measurement 126, and SINR measurement 128 values acquired during an assessment window. The registration status 232 records the outcome of the attempted connection to the network sector 106, including whether the endpoint device 108 successfully registered, the number of retries attempted, and any exception or error information. The assessment data 225 preserves these records in the one or more memories 208 so that the endpoint device 108 can respond to later queries from the mobile device 120 and provide historical connectivity information for troubleshooting and performance tracking.

The measurement log 230 records the raw and processed signal quality values acquired during a cellular assessment. In some embodiments, the measurement log 230 also stores metadata such as the time each sample was taken, the number of samples collected, and the average or aggregated values used for classification. The measurement log 230 preserves these values in the one or more memories 208 to support subsequent retrieval by the instruction handler 220 and transmission to the mobile device 120 for review by the registration companion application 122.

The registration status 232 records the outcome of an endpoint device 108 attempting to register with a network sector 106 during a cellular assessment. The registration status 232 specifies whether the endpoint device 108 successfully established a connection, failed to connect, or encountered an error condition. In some embodiments, the registration status 232 further includes diagnostic details such as the number of retries attempted, authentication responses from the carrier network 104, or error codes describing the failure.

The assessment properties 234 store supplemental information that describes contextual details of a given cellular assessment. For example, the assessment properties 234 can correspond to the properties of the cellular assessment 130 and provide a structured representation of that information within the computing system 200. The assessment properties 234 include, without limitation, the start time of the assessment, the total duration of the assessment, identifiers for the carrier network 104 or network sector 106 involved in the attempt, and any exceptions encountered during operation. In some embodiments, the assessment properties 234 also store derived values such as an assessment identifier, the classification level assigned by the registration application 110, and other metadata that enable consistent reporting and retrieval of historical assessments. The assessment properties 234 provide structured information that complement the measurement log 230 and the registration status 232.

The sector and operator information 236 stores values identifying the network resources associated with a cellular assessment. The sector and operator information 236 includes, without limitation, identifiers for the serving cell, the carrier operator name, operator numbers, configured LTE bands, and tracking area codes. In some embodiments, the sector and operator information 236 also includes data relating to cell identifiers or sector identifiers broadcast by the carrier network 104. By storing this information, the endpoint device 108 associates each set of measurements and registration outcomes with the specific carrier and network sector being evaluated, thereby enabling accurate troubleshooting, comparative analysis between carriers, and record-keeping for deployment validation.

### Mobile Device

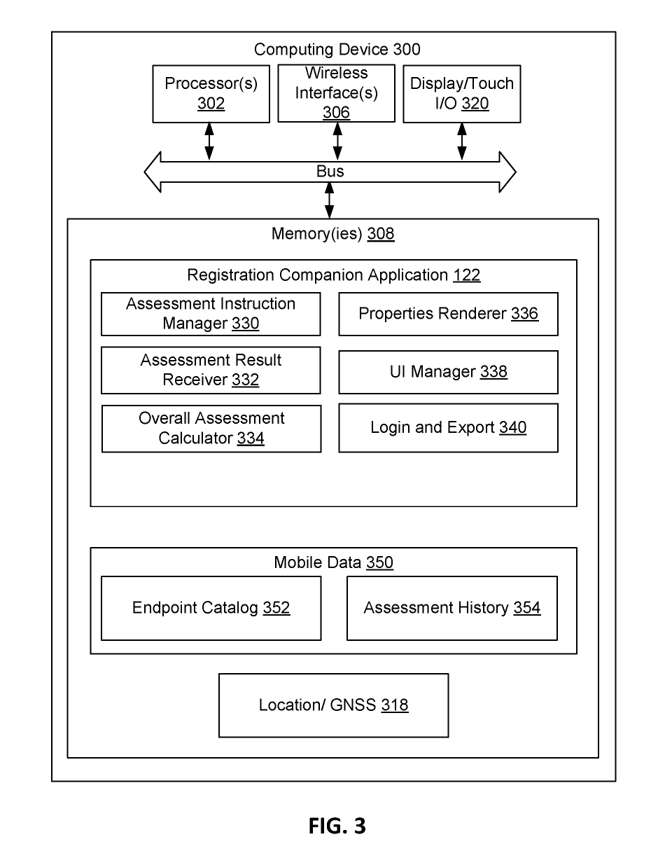

FIG. 3 is a block diagram of a computing device 300 of a mobile device, according to various embodiments. The computing device 300 includes, without limitation, one or more processors 302, one or more wireless interfaces 306, and a display/touch I/O 320, and one or more memories 308 coupled and in communication via a bus. The one or more memories 308 include, without limitation, the registration companion application 122 and mobile data 350. The registration companion application 122 includes, without limitation, an assessment instruction manager 330, an assessment result receiver 332, an overall assessment calculator 334, a properties renderer 336, a user interface (UI) manager 338, and a login and export module 340. The mobile data 350 includes, without limitation, an endpoint catalog 352 and an assessment history 354.

The computing device 300 provides the hardware and software platform of the mobile device 120 that executes the registration companion application 122. In various embodiments, the computing device 300 corresponds to a smartphone, tablet, laptop, handheld computer, or other portable electronic device equipped with wireless communication capabilities and a user interface.

The one or more processors 302 execute instructions and process data for the computing device 300. Each processor 302 includes hardware configured to perform arithmetic operations, logical operations, and control operations in support of the registration companion application 122 and associated modules. A processor 302 can include, without limitation, a central processing unit (CPU), a digital signal processor (DSP), a graphics processing unit (GPU), a microcontroller, an application-specific integrated circuit (ASIC), a field-programmable gate array (FPGA), or any combination thereof. The one or more processors 302 coordinate operations among the wireless interfaces 306, the memories 308, and the display/touch I/O 320, ensuring that assessment instructions, received results, and rendered properties are processed in real time.

The one or more wireless interfaces 306 provide the physical and logical communication links between the computing device 300 and external systems. The wireless interfaces 306 support communication with the endpoint device 108 over short-range or wired connections, as well as communication with carrier networks 104 over wide-area cellular connections. The wireless interfaces 306 include, without limitation, a Bluetooth transceiver, a Wi-Fi transceiver, a cellular modem, a near-field communication (NFC) interface, a Universal Serial Bus (USB) port, and/or the like. The wireless interfaces 306 transmit commands from the assessment instruction manager 330 to the endpoint device 108 and receive signal quality measurements, registration statuses, and assessment properties from the assessment result receiver 332. The wireless interfaces 306 operate under applicable communication standards and protocols including, without limitation, LTE, 5G, Wi-Fi, Bluetooth Low Energy, and/or the like.

The one or more memories 308 provide storage for executable instructions and persistent data within the computing device 300. The one or more memories store the registration companion application 122, including the assessment instruction manager 330, the assessment result receiver 332, the overall assessment calculator 334, the properties renderer 336, the UI manager 338, and the login and export module 340. The one or more memories 308 also store the mobile data 350, including the endpoint catalog 352 and the assessment history 354. The one or more memories 308 can include, without limitation, a random access memory (RAM) device, a flash memory device, a solid-state drive (SSD), non-volatile storage, or any other type of memory device and/or combination thereof. The one or more processors 302 access the memories 308 to load instructions, retrieve stored data, and maintain execution states of the registration companion application 122.

The wireless interface(s) 306 include devices configured to transmit and receive data between the computing device 300 and external systems. The wireless interface(s) 306 support communication with the endpoint device 108 through short-range or wired connections, as well as with one or more carrier networks 104 through wide-area cellular connections. In various embodiments, the wireless interface(s) 306 include, without limitation, a Bluetooth transceiver, a Wi-Fi transceiver, a cellular modem, a near-field communication (NFC) interface, a Universal Serial Bus (USB) port, and/or the like. The wireless interface(s) 306 provide the physical and logical link by which the registration companion application 122 exchanges commands, signal quality measurements, and assessment properties with the endpoint device 108 and with remote servers, and the wireless interface(s) 306 operate under applicable communication standards and protocols such as LTE, 5G, Wi-Fi, Bluetooth Low Energy, and/or the like.

The location/Global Navigation Satellite System (GNSS) 318 provides geographic position and timing information to the computing device 300. The location/GNSS 318 interfaces with a satellite signal receiver (not shown) and can include, without limitation, associated firmware for determining coordinates, time information, and/or the like. The location/GNSS 318 supplies location data to the registration companion application 122 for associating cellular assessment results with installation sites. In some embodiments, the location/GNSS 318 operates with multiple navigation constellations such as GPS, GLONASS, Galileo, or BeiDou, and integrates augmentation systems such as Differential GPS (DGPS) or Satellite-Based Augmentation Systems (SBAS) to improve accuracy. More generally, the location/GNSS 318 communicates determined position data to the assessment history 354 for recordkeeping and to the properties renderer 336 for optional display to a field worker.

The display/touch I/O 320 provides visual output and user input capabilities for the computing device 300. The display/touch I/O 320 includes, without limitation, a graphical display screen, a touchscreen sensing layer, and associated drivers for rendering visual elements and receiving user interactions. The display/touch I/O 320 presents the user interface generated by the registration companion application 122, including signal quality measurements, properties of the cellular assessment, and overall assessment values. The display/touch I/O 320 receives touch gestures, keypad entries, or stylus inputs from a field worker for initiating commands, navigating screens, and confirming results. In some embodiments, the display/touch I/O 320 includes auxiliary output components such as backlighting, haptic feedback actuators, or speakers, and input components such as microphones or external buttons for multimodal interaction. The display/touch I/O 320 enables the field worker to monitor, control, and record assessment functions during deployment of the endpoint device 108 and/or the like.

The registration companion application 122 includes executable instructions stored in the one or more memories 308 and executed by the one or more processors 302 to perform cellular assessment management functions on the computing device 300. The registration companion application 122 coordinates the operations of the assessment instruction manager 330, the assessment result receiver 332, the overall assessment calculator 334, the properties renderer 336, the user interface manager 338, and the login and export module 340. The registration companion application 122 maintains data flow between modules, manages timing of commands and responses, and ensures that measurement values, registration status, and assessment properties are processed into structured outputs. In various embodiments, the registration companion application 122 also accesses the endpoint catalog 352 and the assessment history 354 stored in the mobile data 350 to support record-keeping, device identification, and comparative analysis of results.

The assessment instruction manager 330 generates and transmits commands from the registration companion application 122 to the endpoint device 108. The assessment instruction manager 330 constructs commands that initiate cellular assessments, request retrieval of historical results, and/or adjust operational parameters such as assessment duration, retry counts, and timing intervals. The assessment instruction manager 330 formats each instruction according to the communication protocol supported by the wireless interface(s) 306 and appends identifiers that associate the instruction with a specific endpoint device 108 or network sector 106. In various embodiments, the assessment instruction manager 330 also validates user inputs received through the display/touch I/O 320 before issuing corresponding commands, and records issued commands in association with timestamps for later correlation with results stored in the assessment history 354.

The assessment result receiver 332 acquires and processes responses received from the endpoint device 108. The assessment result receiver 332 collects signal quality measurements, registration status values, and properties of the cellular assessment transmitted over the wireless interface(s) 306. The assessment result receiver 332 parses the received data into structured records that can be stored in the assessment history 354 and provided to the overall assessment calculator 334 and properties renderer 336. In various embodiments, the assessment result receiver 332 verifies data integrity using checksums, sequence identifiers, or authentication codes, and discards or flags incomplete or corrupted responses. The assessment result receiver 332 associates each result received from the endpoint device 108 with the corresponding command issued by the assessment instruction manager 330 to preserve traceability of assessment sessions.

The overall assessment calculator 334 computes a classification value that summarizes the cellular connectivity between the endpoint device 108 and the network sector 106. The overall assessment calculator 334 evaluates the signal quality measurements and the one or more properties of the cellular assessment provided by the assessment result receiver 332 against thresholds. The overall assessment calculator 334 determines whether the connectivity corresponds to a high-value classification, a mid-value classification, or a low-value classification, based on combinations of RSRP measurement 124, RSRQ measurement 126, SINR measurement 128, and registration outcomes. In some embodiments, the overall assessment calculator 334 computes additional statistical values such as averages, variances, or sample counts to support more detailed analysis. The overall assessment calculator 334 provides the resulting classification values and supplemental metrics to the properties renderer 336 for formatting and display.

In some embodiments, the overall assessment calculator 334 determines a green classification for the overall assessment 402 when the assessment status indicates a successful registration and the RSRQ measurement 126, the SINR measurement 128, and the RSRP measurement 124 indicate values above respective quality thresholds. For example, the overall assessment calculator 334 determines a green classification when the RSRQ measurement 126 is above –16 dB, the SINR measurement 128 is above 1 dB, and the RSRP measurement 124 is above –116 dBm.

In some embodiments, the overall assessment calculator 334 determines a yellow classification for the overall assessment in situations where the assessment status and the signal quality indicators 124-128 reflect either (i) a successful registration with marginal signal quality (e.g., two of the three signal quality indicators 124-128 indicate reasonable quality) or (ii) a failed registration where the signal quality indicators 124-128 indicate values above the quality thresholds. For example, when the overall assessment calculator 334 determines good signal quality but a failed registration, the overall assessment calculator 334 classifies the connection as yellow to indicate that the failure is attributable to a factor other than radio quality, such as carrier configuration.

In some embodiments, the overall assessment calculator 334 determines a red classification for the overall assessment in situations where the assessment status indicates an unsuccessful registration combined with marginal signal quality (e.g. , two of the three signal quality indicators 124-128 indicate suboptimal values), or a failed registration with no usable signal quality measurements acquired. For example, the registration companion application 122 determines a red classification when the RSRQ measurement 126 is below –19 dB, the SINR measurement 128 is below –3 dB, and/or the RSRP measurement 124 is below –116 dBm.

The properties renderer 336 organizes and formats the assessment data for presentation on the display/touch I/O 320. The properties renderer 336 receives the classification values from the overall assessment calculator 334 and the signal quality measurements, registration status, and assessment properties from the assessment result receiver 332. The properties renderer 336 generates structured outputs such as tables, charts, and labeled values that reflect RSRP measurement 124, RSRQ measurement 126, SINR measurement 128, assessment duration, timestamps, and cell tower identifiers. The properties renderer 336 converts raw data into human-readable indicators, including text, icons, and/or color-coded symbols, and prepares the data for integration into the user interface managed by the UI manager 338. In various embodiments, the properties renderer 336 also formats data for export operations managed by the login and export module 340, ensuring consistent presentation across both on-screen and external reports.

The UI manager 338 controls generation and navigation of the graphical user interface displayed on the display/touch I/O 320. The UI manager 338 arranges content produced by the properties renderer 336 into interactive screens that include assessment results, endpoint identifiers, and historical data. The UI manager 338 processes user inputs such as taps, swipes, or key entries to trigger functions of the registration companion application 122, including initiation of new assessments, retrieval of stored records, or adjustment of configuration parameters. The UI manager 338 manages screen transitions, menu structures, and confirmation dialogs to ensure that assessment results and options are accessible to the field worker. In various embodiments, the UI manager 338 coordinates with the assessment instruction manager 330 and the assessment result receiver 332 so that issued commands and received responses are reflected in real time on the displayed interface.

The login and export module 340 manages authentication of field workers and external transfer of assessment data from the computing device 300. The login and export module 340 enforces access control by verifying user credentials, authorization tokens, or biometric inputs before allowing operation of the registration companion application 122. The login and export module 340 associates authenticated sessions with user identifiers to maintain accountability of issued commands and stored results in the assessment history 354. The login and export module 340 also supports export of assessment results and properties to external systems, such as enterprise servers, cloud storage platforms, or removable media. In various embodiments, the login and export module 340 formats exported data using standardized structures such as comma-separated values (CSV), extensible markup language (XML), or JavaScript object notation (JSON), and transmits the data via secure protocols including Transport Layer Security (TLS), Secure File Transfer Protocol (SFTP), and/or the like.

The mobile data 350 stores structured information generated and maintained by the registration companion application 122 during assessment operations. The mobile data 350 includes, without limitation, the endpoint catalog 352 and the assessment history 354. The mobile data 350 provides persistent storage of device-specific records, assessment identifiers, and contextual details that support ongoing installation, validation, and troubleshooting activities. The mobile data 350 resides in the one or more memories 308 and is accessible by the modules of the registration companion application 122 for retrieving prior results, associating assessments with particular endpoint devices 108, and exporting information through the login and export module 340.

The endpoint catalog 352 maintains a list of endpoint devices 108 known to the registration companion application 122. The endpoint catalog 352 stores identifiers such as subscriber identity module (SIM) numbers, international mobile subscriber identities (IMSI), serial numbers, or device-specific tags associated with each endpoint device 108. The endpoint catalog 352 also records carrier information, configuration parameters, and installation site references for each listed endpoint. The endpoint catalog 352 enables the registration companion application 122 to target commands issued by the assessment instruction manager 330 to a specific endpoint device 108, and to associate received results with the correct device entry. In various embodiments, the endpoint catalog 352 supports updates from new device discoveries, manual user entries via the display/touch I/O 320, or synchronization with enterprise records and/or the like.

The assessment history 354 stores records of prior cellular assessments performed through the registration companion application 122. The assessment history 354 includes, without limitation, measurement values, registration statuses, classification levels computed by the overall assessment calculator 334, and contextual information such as timestamps, assessment duration, and geographic coordinates from the location/GNSS 318. The assessment history 354 enables field workers to review prior assessments for the same endpoint device 108 or across multiple endpoint devices 108 at multiple installation sites, and supports comparative analysis to identify trends or anomalies in connectivity. The assessment history 354 organizes entries by device identifiers from the endpoint catalog 352 and allows retrieval through user interaction with the UI manager 338. In various embodiments, the assessment history 354 also includes export flags or audit trails that record when results have been transmitted externally through the login and export module 340.

### Cellular Assessment Interface

FIG. 4 is a diagram of a cellular assessment interface 400, according to various embodiments. As shown, the cellular assessment interface 400 includes, without limitation, an overall assessment 402, an endpoint identifier 404, an assessment status 406, an assessment time indicator 408, an assessment duration 410, a cellular tower identifier 412, an RSRQ indicator 414, an SINR indicator 416, and an RSRP indicator 418.

In various embodiments, the registration companion application 122 receives the information from the registration application 110 of the endpoint device 108 in response to a carrier assessment (e.g., the RSRP measurement 124, the RSRQ measurement 126, the SINR measurement 128 and/or the one or more properties of the cellular assessment 130) performed by the registration application 110. The registration companion application 122 can then include the overall assessment 402 with the received information in the cellular assessment interface 400.

The registration companion application 122 receives information from the registration application 110 of the endpoint device 108 relating to a carrier assessment (e.g., the signal quality measurements 124–128 and/or the properties of the cellular assessment 130). The registration companion application 122 generates the overall assessment 402 based on the received information. The registration companion application 122 then includes the overall assessment 402 with the received information in the cellular assessment interface 400.

The registration companion application 122 generates the RSRQ indicator 414, the SINR indicator 416, and the RSRP indicator 418 that represent, respectively, the RSRQ measurement 126, the SINR measurement 128, and the RSRP measurement 124 acquired by the registration application 110 during the carrier assessment. The registration companion application 122 represents these signal quality measurements using specific values (e.g., an RSRQ measurement of –9 dB) and/or visual indicators (e.g., a pictograph indicating relative quality using colored bars, icons, or other graphics).

The registration companion application 122 displays portions of the properties of the cellular assessment 130, including values associated with the endpoint identifier 404, the assessment status 406, the assessment time indicator 408, the assessment duration 410, and the cellular tower identifier 412. The endpoint identifier 404 corresponds to a subscriber identity module (SIM) identifier, an international mobile subscriber identity (IMSI), or another identifier uniquely associated with the endpoint device 108. The assessment status 406 specifies whether the endpoint device 108 successfully registered with the network sector 106. The assessment time indicator 408 provides a timestamp of the assessment, and the assessment duration 410 specifies the elapsed time of the assessment. The cellular tower identifier 412 identifies the serving cell tower or sector (e.g., a sector identifier or cell ID broadcast by the carrier network 104).

The overall assessment 402 corresponds to the assessment generated by overall assessment calculator 334. The overall assessment 402 is presented together with the other assessment data on the cellular assessment interface 400. In some embodiments, the overall assessment 402 is displayed in a color reflecting a classification type for the overall assessment 402. For example, the color could be green, yellow, or red. A green classification corresponds to a high-value classification, a yellow classification corresponds to a mid-value classification, and a red classification corresponds to a low-value classification. The overall assessment 402 can also be displayed using graphical icons and/or text. In some embodiments, the overall assessment 402 is also accompanied by corresponding haptic outputs, audio tones, and/or the like.

### Methods for Cellular Assessment

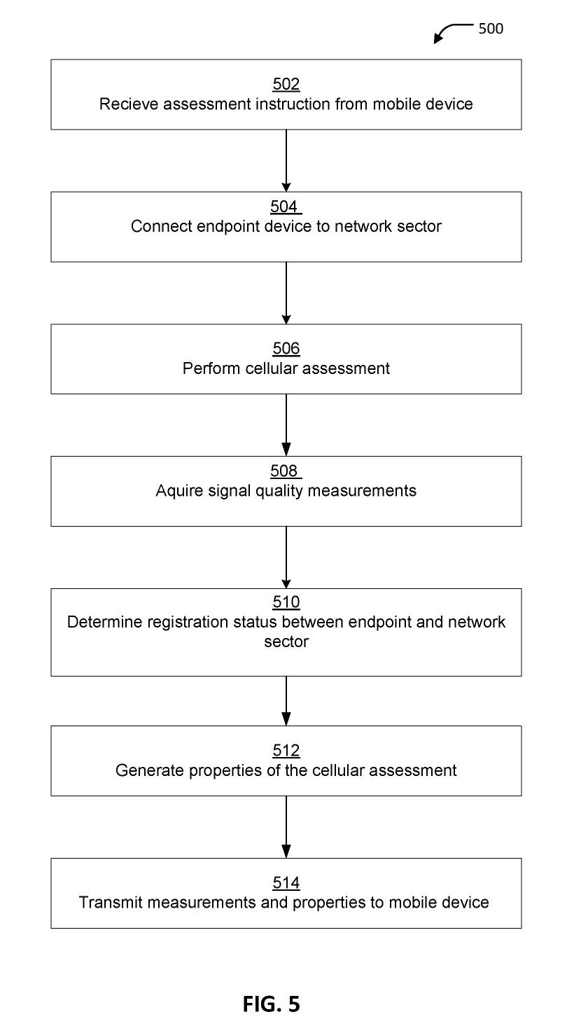

FIG. 5 is a flow diagram of method steps for performing a cellular assessment, according to various embodiments. Although the method steps are described in conjunction with the systems of FIGS. 1–3 and the embodiments of FIG. 4, persons of ordinary skill in the art will understand that any system configured to perform the method steps, in any order, is within the scope of the invention.

As shown, a method 500 begins at step 502, where the instruction handler 220 receives an assessment instruction from the mobile device 120. The assessment instruction specifies parameters that govern execution of the cellular assessment, such as a target network sector 106, an intended assessment duration, retry counts, or other configuration values. The instruction handler 220 records the assessment instruction in association with an identifier to ensure that subsequently generated signal quality measurements 124–128 and properties of the cellular assessment 130 correspond to the issued instruction.

At step 504, the cellular assessment engine 210 connects the endpoint device 108 to a network sector 106. The cellular assessment engine 210 initiates signaling through the network interfaces 206 to attempt attachment and registration with the selected network sector 106. The connection process includes exchanging control messages, authenticating with the carrier network 104, and establishing a communication channel suitable for measurement collection. The registration application 110 associates the attempted connection with the active assessment identifier to preserve traceability of the resulting measurements and properties.

At step 506, the cellular assessment engine 210 performs a cellular assessment. The cellular assessment engine 210 coordinates operations of the modem statistics collector 212, the signal quality sampler 214, and the registration status module 216 to initiate connection attempts, control timing windows, and manage retries. The cellular assessment includes collecting data during the attachment procedure, monitoring radio conditions during the connection process, and preparing the endpoint device 108 for subsequent measurement acquisition. The cellular assessment engine 210 ensures that the cellular assessment is executed in accordance with the parameters specified in the assessment instruction received at step 502.

At step 508, the signal quality sampler 214 acquires signal quality measurements 124–128. The signal quality measurements 124-128 correspond to the signals measured during the attempted connection between the endpoint device 108 and the network sector 106. The signal quality sampler 214 records values of RSRP measurement 124, RSRQ measurement 126, and SINR measurement 128 during the assessment window. Depending upon the assessment instruction received during step 502, the acquired signal quality measurements 124-128 include per-sample timestamps, aggregated averages, and/or extrema. The signal quality sampler 214 associates the acquired measurements with the assessment identifier to ensure consistent traceability within the properties of the cellular assessment 130.

At step 510, the registration status module 116 determines a registration status 232 between the endpoint device 108 and the network sector 106. The registration status module 216 evaluates control signaling exchanged during the connection attempt to determine whether registration succeeded, failed, or produced an error condition. The registration status 232 includes diagnostic details such as the number of retries attempted, authentication results, and error codes generated by the carrier network 104 and/or the modem of the endpoint device 108. The registration status module 116 records the registration status 232 in association with the active assessment identifier for subsequent inclusion in the properties of the cellular assessment 130.

At step 512, the assessment properties generator 218 generates the properties of the cellular assessment 130. The assessment properties generator 218 combines contextual information such as the start time, end time, and total duration of the assessment with identifiers for the carrier network 104 and network sector 106, the registration status 232, and any recorded error codes. The assessment properties generator 218 formats this information as assessment properties 234 for structured storage within the assessment data 225. The assessment properties generator 218 associates the assessment properties 234 with the corresponding measurement log 230 and registration status 232 to create a complete record of the cellular assessment.

At step 514, the transmitter/encoder 222 transmits the signal quality measurements 124–128 and the properties of the cellular assessment 130 to the mobile device 120. The transmitter/encoder 222 formats the measurement log 230, the registration status 232, and the assessment properties 234 for delivery over a short-range wireless or wired connection. The registration application 110 ensures that the transmitted information includes the assessment identifier to preserve association between the received results and the original instruction issued at step 502. The transmitted information enables the registration companion application 122 to compute an overall assessment value and display the cellular assessment results to the field worker through the user interface of the mobile device 120.

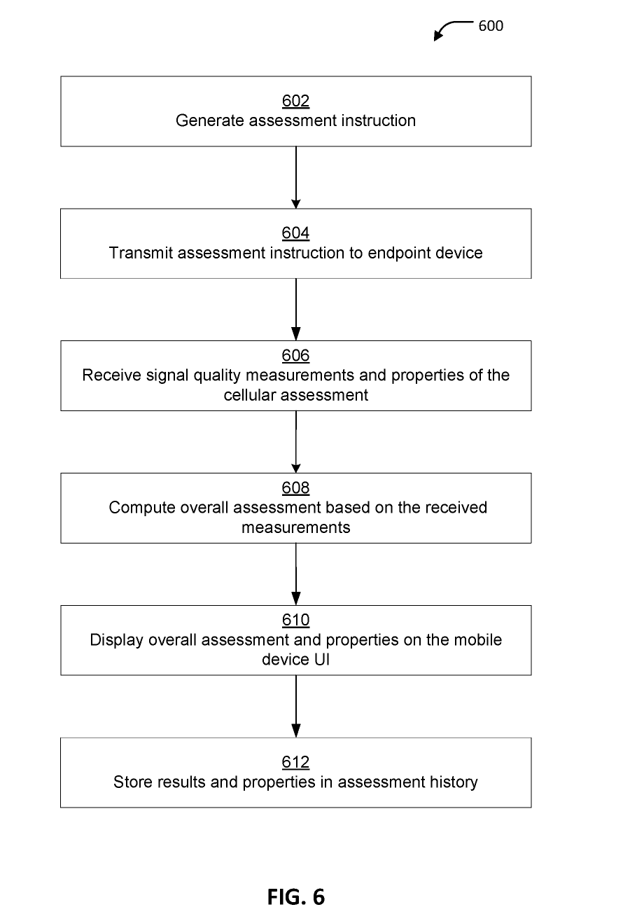

FIG. 6 is a flow diagram of method steps for requesting a cellular assessment and generating an overall cellular assessment result, according to various embodiments. Although the method steps are described in conjunction with the systems of FIGS. 1–3, persons of ordinary skill in the art will understand that any system configured to perform the method steps, in any order, is within the scope of the invention.

As shown, a display method 600 begins at step 602, where the assessment instruction manager 330 generates an assessment instruction for delivery to the endpoint device 108. The assessment instruction manager 330 specifies operational parameters for the cellular assessment, including a target network sector 106, an assessment duration, retry counts, timing intervals, and/or the like. The assessment instruction manager 330 associates the generated instruction with an endpoint entry maintained in the endpoint catalog 352 to ensure that the instruction corresponds to a specific endpoint device 108. The assessment instruction manager 330 records the generated instruction in association with a timestamp for subsequent correlation with received results.

At step 604, the assessment instruction manager 330 transmits the assessment instruction to the endpoint device 108 using the wireless interfaces 306 of the computing device 300. The assessment instruction manager 330 formats the instruction according to the communication protocol supported by the endpoint device 108 and appends identifiers linking the instruction to the selected entry in the endpoint catalog 352. The assessment instruction manager 330 ensures reliable delivery of the instruction by applying framing, sequence identifiers, and authentication values and/or the like, thereby enabling the endpoint device 108 to initiate the cellular assessment in accordance with the specified parameters.

At step 606, the assessment result receiver 332 receives the signal quality measurements 124–128 and the properties of the cellular assessment 130 from the endpoint device 108. In some embodiments, the assessment result receiver 332 receives the signal quality measurements 124–128 and the properties of the cellular assessment 130 through the wireless interfaces 306. The assessment result receiver 332 then parses the signal quality measurements 124–128 and the properties of the cellular assessment 130 into structured records. In some embodiments, the assessment result receiver 332 validates the integrity of the signal quality measurements 124–128 and the properties of the cellular assessment 130 using checksums, sequence identifiers, or authentication codes and discards or flags incomplete or corrupted responses.

At step 608, the overall assessment calculator 334 computes the overall assessment 402 based on the signal quality measurements 124–128 included in the received information and on the registration status 232 as provided in the properties of the cellular assessment 130. The overall assessment calculator 334 evaluates the RSRP measurement 124, the RSRQ measurement 126, and the SINR measurement 128 against thresholds and combines the results with the registration status 232 to generate a classification of connectivity. The classification specifies a high-value, mid-value, or low-value outcome corresponding to the likelihood of successful operation at the installation site. The overall assessment calculator 334 also records supporting statistical values such as averages, variances, or sample counts and/or the like to provide context for the classification. The computed overall assessment 402 is forwarded to the properties renderer 336 for formatting and display.

At step 610, the properties renderer 336 and the UI manager 338 display the overall assessment 402 and associated properties of the cellular assessment 130 on the user interface of the computing device 300. The properties renderer 336 organizes the overall assessment 402 together with the endpoint identifier 404, the assessment status 406, the assessment time indicator 408, the assessment duration 410, the cellular tower identifier 412, the RSRQ indicator 414, the SINR indicator 416, and the RSRP indicator 418. The UI manager 338 integrates these elements into interactive screens presented on the display/touch I/O 320, enabling a field worker to view assessment outcomes, navigate among results, and initiate subsequent commands.

At step 612, the registration companion application 122 stores the overall assessment 402, the signal quality measurements 124–128, and the properties of the cellular assessment 130 in the assessment history 354. The registration companion application 122 associates the overall assessment 402, the signal quality measurements 124–128, and the properties of the cellular assessment 130 with the corresponding endpoint entry in the endpoint catalog 352 and preserves contextual data such as timestamps from the assessment time indicator 408 and geographic coordinates from the location/GNSS 318. The registration companion application 122 also stores audit details including the identity of the field worker authenticated by the login and export module 340 and export flags indicating whether the results were transmitted to external systems. The stored information provide a historical record for comparative analysis of connectivity across multiple endpoint devices 108 and installation sites.

In sum, techniques are disclosed herein for performing on-site cellular connectivity assessments at an actual location where an endpoint device is installed. The endpoint device executes a registration application that connects to a network sector of a carrier network to establish a cellular connection. During a cellular assessment, the registration application acquires a plurality of signal quality measurements for the cellular connection, such as RSRP measurement 124, RSRQ measurement 126, and SINR measurement 128. In addition, the registration application generates one or more properties of the cellular assessment, such as registration success or failure, assessment duration, cell identifier, and/or the like. The registration application transmits the plurality of signal quality measurements and the one or more properties of the cellular assessment to a mobile device for further processing and display. The mobile device processes the received measurements and properties to generate an overall assessment value and displays the overall assessment value on a user interface, thereby enabling localized carrier viability testing at the installation site without reliance on external maps or off-site systems.

The following clauses describe aspects of various embodiments.
1. In some embodiments, a method comprises connecting, via an endpoint device installed at a location, to a network sector to establish a cellular connection with the network sector, wherein the network sector is provided by a carrier network, performing, by a registration application executing on the endpoint device, a cellular assessment that acquires a plurality of signal quality measurements for the cellular connection, and transmitting, by the registration application to a mobile device, the plurality of signal quality measurements and one or more properties of the cellular assessment, wherein the plurality of signal quality measurements and the one or more properties are usable by the mobile device to determine an overall assessment of connectivity between the endpoint device and the network sector.
2. The method of clause 1, further comprising determining, by the registration application, a registration status between the endpoint device and the network sector, wherein the registration status is included in the one or more properties of the cellular assessment.
3. The method of clauses 1 or 2, further comprising receiving, by the registration application, a command from the mobile device to perform a subsequent cellular assessment, and performing, by the registration application, a second cellular assessment that acquires a second plurality of signal quality measurements for the cellular connection.
4. The method of any of clauses 1-3, wherein the endpoint device stores the plurality of signal quality measurements.
5. The method of any of clauses 1-4, wherein the location is located on a power pole or in a subterranean box.
6. The method of any of clauses 1-5, wherein the one or more properties of the cellular assessment include at least one of an identifier of the endpoint device or an identifier of the network sector.
7. The method of any of clauses 1-6, wherein the one or more properties of the cellular assessment include a timestamp indicating when the cellular assessment was performed.
8. The method of any of clauses 1-7, wherein the endpoint device comprises a utility meter or a streetlight controller.
9. In some embodiments, a method comprises transmitting, by a registration companion application executing on a mobile device, a command to an endpoint device to perform a cellular assessment, wherein the endpoint device is installed at a location, receiving, by the registration companion application from the endpoint device, a plurality of signal measurements and one or more cellular assessment characteristics, and generating, by the registration companion application based on the plurality of signal measurements and the one or more cellular assessment characteristics, an overall assessment of connectivity between the endpoint device and a network sector.
10. The method of clause 9, wherein generating the overall assessment of connectivity is further based on a connection status included in the one or more cellular assessment characteristics.
11. The method of clauses 9 or 10, further comprising in response to determining that the connection status indicates a registration between the endpoint device and the network sector failed, transmitting, by the registration companion application to the endpoint device, a command to perform a subsequent cellular assessment.
12. The method of any of clauses 9-11, further comprising transmitting, by the registration companion application to the endpoint device, a command to perform a subsequent cellular assessment, and receiving, by the registration companion application, a second plurality of signal measurements for the subsequent cellular assessment.
13. The method of any of clauses 9-12, wherein the plurality of signal measurements comprises two or more of a reference signal received power (RSRP) measurement, a reference signal received quality (RSRQ) measurement, or a signal-to-interference-plus-noise ratio (SINR) measurement, and generating the overall assessment of connectivity comprises generating a classification by comparing at least one of the RSRP measurement, the RSRQ measurement, or the SINR measurement to a respective threshold.
14. The method of any of clauses 9-13, wherein the overall assessment of connectivity comprises a high-value classification when a connection status between the endpoint device and the network sector is a successful connection with the network sector, the RSRP measurement is above a first threshold, the RSRQ measurement is above a second threshold, and the SINR measurement is above a third threshold.
15. The method of any of clauses 9-14, wherein the overall assessment of connectivity comprises a mid-value classification when at least one of a connection status between the endpoint device and the network sector is a successful connection with the network sector and a majority of the RSRP measurement, the RSRQ measurement, and the SINR measurement are above respective thresholds, or the connection status is an unsuccessful connection with the network sector and the RSRP measurement is above a first threshold, the RSRQ measurement is above a second threshold, and the SINR measurement is above a third threshold.
16. The method of any of clauses 9-15, wherein the overall assessment of connectivity comprises a low-value classification when at least one of a connection status between the endpoint device and the network sector is an unsuccessful connection with the network sector, or a majority of the RSRP measurement, the RSRQ measurement, and the SINR measurement are below respective thresholds.
17. In some embodiments, an endpoint device installed at a location, the endpoint device comprises one or more processors, one or more network interfaces configured to establish a cellular connection, and a memory storing a registration application comprises executable instructions that, when executed by the one or more processors, cause the one or more processors to perform operations comprising in response to receiving, from a mobile device, a command to assess connectivity with a network sector of a cellular network assessing the connectivity with the network sector, the assessing comprising acquiring a plurality of signal quality measurements for the connectivity with the network sector, determining a connection state between the endpoint device and the network sector, and transmitting the plurality of signal quality measurements and the connection state to the mobile device.
18. The endpoint device of clause 17, wherein the location is located on a power pole or in a subterranean box, and the endpoint device comprises a utility meter or a streetlight controller.
19. The endpoint device of clauses 17 or 18, wherein the operations further comprise transmitting at least one of an identifier of the endpoint device or an identifier of the network sector to the mobile device.
20. The endpoint device of any of clauses 17-19, wherein the operations further comprise storing the plurality of signal quality measurements and the connection state with a timestamp indicating when the assessing of the connectivity with the network sector was performed.

Any and all combinations of any of the claim elements recited in any of the claims and/or any elements described in this application, in any fashion, fall within the contemplated scope of the present protection.

The descriptions of the various embodiments have been presented for purposes of illustration, but are not intended to be exhaustive or limited to the embodiments disclosed. Many modifications and variations will be apparent to those of ordinary skill in the art without departing from the scope and spirit of the described embodiments.

Aspects of the present embodiments may be embodied as a system, method or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “module,” a “system,” or a “computer.” In addition, any hardware and/or software technique, process, function, component, engine, module, or system described in the present disclosure may be implemented as a circuit or set of circuits. Furthermore, aspects of the present disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Aspects of the present disclosure are described above with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine. The instructions, when executed via the processor of the computer or other programmable data processing apparatus, enable the implementation of the functions/acts specified in the flowchart and/or block diagram block or blocks. Such processors may be, without limitation, general purpose processors, special-purpose processors, application-specific processors, or field-programmable gate arrays.

The flowchart and block diagrams in the figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While the preceding is directed to embodiments of the present disclosure, other and further embodiments of the disclosure may be devised without departing from the basic scope thereof, and the scope thereof is determined by the claims that follow.

What is claimed is:

1. A method comprising:
connecting, via an endpoint device installed at a location, to a network sector to establish a cellular connection with the network sector, wherein the network sector is provided by a carrier network;
performing, by a registration application executing on the endpoint device, a cellular assessment that acquires a plurality of signal quality measurements for the cellular connection; and
transmitting, by the registration application to a mobile device, the plurality of signal quality measurements and one or more properties of the cellular assessment, wherein the plurality of signal quality measurements and the one or more properties are usable by the mobile device to determine an overall assessment of connectivity between the endpoint device and the network sector.

2. The method of claim 1, further comprising:
determining, by the registration application, a registration status between the endpoint device and the network sector,
wherein the registration status is included in the one or more properties of the cellular assessment.

3. The method of claim 1, further comprising:
receiving, by the registration application, a command from the mobile device to perform a subsequent cellular assessment; and
performing, by the registration application, a second cellular assessment that acquires a second plurality of signal quality measurements for the cellular connection.

4. The method of claim 1, wherein the endpoint device stores the plurality of signal quality measurements.

5. The method of claim 1, wherein the location is located on a power pole or in a subterranean box.

6. The method of claim 1, wherein the one or more properties of the cellular assessment include at least one of an identifier of the endpoint device or an identifier of the network sector.

7. The method of claim 1, wherein the one or more properties of the cellular assessment include a timestamp indicating when the cellular assessment was performed.

8. The method of claim 1, wherein the endpoint device comprises a utility meter or a streetlight controller.

9. A method comprising:
transmitting, by a registration companion application executing on a mobile device, a command to an endpoint device to perform a cellular assessment, wherein the endpoint device is installed at a location;
receiving, by the registration companion application from the endpoint device, a plurality of signal measurements and one or more cellular assessment characteristics; and
generating, by the registration companion application based on the plurality of signal measurements and the one or more cellular assessment characteristics, an overall assessment of connectivity between the endpoint device and a network sector.

10. The method of claim 9, wherein generating the overall assessment of connectivity is further based on a connection status included in the one or more cellular assessment characteristics.

11. The method of claim 10, further comprising in response to determining that the connection status indicates a registration between the endpoint device and the network sector failed, transmitting, by the registration companion application to the endpoint device, a command to perform a subsequent cellular assessment.

12. The method of claim 9, further comprising:
transmitting, by the registration companion application to the endpoint device, a command to perform a subsequent cellular assessment; and
receiving, by the registration companion application, a second plurality of signal measurements for the subsequent cellular assessment.

13. The method of claim 9, wherein:
the plurality of signal measurements comprises two or more of:
a reference signal received power (RSRP) measurement;
a reference signal received quality (RSRQ) measurement; or
a signal-to-interference-plus-noise ratio (SINR) measurement; and
generating the overall assessment of connectivity comprises generating a classification by comparing at least one of the RSRP measurement, the RSRQ measurement, or the SINR measurement to a respective threshold.

14. The method of claim 13, wherein the overall assessment of connectivity comprises a high-value classification when a connection status between the endpoint device and the network sector is a successful connection with the network sector, the RSRP measurement is above a first threshold, the RSRQ measurement is above a second threshold, and the SINR measurement is above a third threshold.

15. The method of claim 13, wherein the overall assessment of connectivity comprises a mid-value classification when at least one of:
a connection status between the endpoint device and the network sector is a successful connection with the network sector and a majority of the RSRP measurement, the RSRQ measurement, and the SINR measurement are above respective thresholds; or
the connection status is an unsuccessful connection with the network sector and the RSRP measurement is above a first threshold, the RSRQ measurement is above a second threshold, and the SINR measurement is above a third threshold.

16. The method of claim 13, wherein the overall assessment of connectivity comprises a low-value classification when at least one of:
a connection status between the endpoint device and the network sector is an unsuccessful connection with the network sector; or
a majority of the RSRP measurement, the RSRQ measurement, and the SINR measurement are below respective thresholds.

17. An endpoint device installed at a location, the endpoint device comprising:
one or more processors;
one or more network interfaces configured to establish a cellular connection; and
a memory storing a registration application comprising executable instructions that, when executed by the one or more processors, cause the one or more processors to perform operations comprising:
in response to receiving, from a mobile device, a command to assess connectivity with a network sector of a cellular network:
assessing the connectivity with the network sector, the assessing comprising acquiring a plurality of signal quality measurements for the connectivity with the network sector;
determining a connection state between the endpoint device and the network sector; and
transmitting the plurality of signal quality measurements and the connection state to the mobile device.

18. The endpoint device of claim 17, wherein:
the location is located on a power pole or in a subterranean box; and
the endpoint device comprises a utility meter or a streetlight controller.

19. The endpoint device of claim 17, wherein the operations further comprise transmitting at least one of an identifier of the endpoint device or an identifier of the network sector to the mobile device.

20. The endpoint device of claim 17, wherein the operations further comprise storing the plurality of signal quality measurements and the connection state with a timestamp indicating when the assessing of the connectivity with the network sector was performed.
